(19) United States
(12) Patent Application Publication
(10) Pub. No.: US 2020/0136479 A1
(43) Pub. Date: Apr. 30, 2020

(54) ELECTRIC MOTOR WITH AN INTEGRAL MOTOR CONTROLLER

(71) Applicant: STOLLMEYER TECHNOLOGIES LLC, San Luis Obispo, CA (US)

(72) Inventors: MARCUS RICHARD STOLLMEYER, SANTA MARIA, CA (US); JOSEPH RILEY COPLON, SAN LUIS OBISPO, CA (US)

(21) Appl. No.: 16/177,247

(22) Filed: Oct. 31, 2018

(51) Int. Cl. H02K 11/33; H02K 15/14; B64C 39/02

(52) U.S. Cl. CPC H02K 11/33; B64C 2201/042; B64C 39/024; H02K 15/14

(57) ABSTRACT

A motor unit system is described. The motor unit system may include a housing with a circular cross-section and a brushless direct current motor with a shaft and a winding, the shaft extending from inside the housing to outside of the housing. A motor controller may also be contained within the housing, along with a first connector and a second connector. The first connector may include a first pair of contacts electrically coupled to the motor controller at a power supply input. The second connector may be adapted to operate independently from the first connector, and may include a second pair of contacts electrically coupled to the motor controller at a control input.

This application relates to the following applications filed concurrently herewith. The related applications, all of which are incorporated herein by reference, are:

Attorney Docket No. 20966-143349-US, U.S. patent application Ser. No.______, of Stollmeyer, et al., entitled ELECTRIC MOTOR WITH NAVIGATIONAL LIGHT;

Attorney Docket No. 20966-143351-US, U.S. patent application Ser. No.______, of Stollmeyer, et al., entitled ELECTRIC MOTOR WITH INTEGRATED MOTOR CONTROLLER; and

Attorney Docket No. 20966-143352-US, U.S. patent application Ser. No.______, of Stollmeyer, et al., entitled ELECTRIC MOTOR WITH SENSORS.

### BACKGROUND OF THE INVENTION

### 1. Field of the Invention

The present invention relates generally to an electric motor, and more specifically to an electric motor that includes an integral motor controller.

### 2. Discussion of the Related Art

Various systems and processes are known in the art for powering a propulsion system. For example, a propulsion system for an unmanned vehicle may include an electric motor. In some cases, the electric motor is powered by an external battery and controlled by a separate controller.

However, in some cases using a separate motor and motor controller may result in inconvenient assembly, and suboptimal performance.

### SUMMARY

A motor unit system is described. The motor unit system may include a housing including a circular cross-section and further including a plurality of mounting holes on one end of the housing, a brushless direct current motor including a shaft and a winding, the shaft extending from inside the housing to outside of the housing through a hole at the one end of the housing or another end of the housing, the other end of the housing being opposite the one end of the housing, the winding being contained within the housing, a motor controller contained within the housing, a first connector accessible through a first opening in the housing, the first connector including a first pair of contacts electrically coupled to the motor controller at a power supply input of the motor controller, and a second connector adapted to operate independently from the first connector accessible through a second opening in the housing, the second connector including a second pair of contacts electrically coupled to the motor controller at a control input of the motor controller.

An unmanned vehicle is described. The unmanned vehicle may include a frame, one or more propulsion units, and a motor unit system; the motor unit system including a housing including a circular cross-section and further including a plurality of mounting holes on one end of the housing, a brushless direct current motor including a shaft and a winding, the shaft extending from inside the housing to outside of the housing through a hole at the one end of the housing or another end of the housing, the other end of the housing being opposite the one end of the housing, the winding being contained within the housing, a motor controller contained within the housing, a first connector accessible through a first opening in the housing, the first connector including a first pair of contacts electrically coupled to the motor controller at a power supply input of the motor controller, and a second connector adapted to operate independently from the first connector accessible through a second opening in the housing, the second connector including a second pair of contacts electrically coupled to the motor controller at a control input of the motor controller.

A method of manufacturing a motor unit system is described. The method may include providing a housing including a circular cross-section and further including a plurality of mounting holes on one end of the housing, providing a brushless direct current motor including a shaft and a winding, the shaft extending from inside the housing to outside of the housing through a hole at the one end of the housing or another end of the housing, the other end of the housing being opposite the one end of the housing, the winding being contained within the housing, providing a motor controller contained within the housing, providing a first connector accessible through a first opening in the housing, the first connector including a first pair of contacts electrically coupled to the motor controller at a power supply input of the motor controller, and providing a second connector adapted to operate independently from the first connector accessible through a second opening in the housing, the second connector including a second pair of contacts electrically coupled to the motor controller at a control input of the motor controller.

In some examples of the motor unit system, unmanned vehicle, and method described above, the first pair of contacts include a first pair of pins. In some examples of the motor unit system, unmanned vehicle, and method described above, the first pair of pins are fully contained within the housing.

In some examples of the motor unit system, unmanned vehicle, and method described above, the second pair of contacts include a second pair of pins. In some examples of the motor unit system, unmanned vehicle, and method described above, the second pair of pins are fully contained within the housing. In some examples of the motor unit system, unmanned vehicle, and method described above, the first pair of contacts include a first pair of pins, and the second pair of contacts include a second pair of pins.

In some examples of the motor unit system, unmanned vehicle, and method described above, the first pair of pins are fully contained within the housing, and wherein the second pair of pins are fully contained within the housing. In some examples of the motor unit system, unmanned vehicle, and method described above, the first pair of contacts include a first set of wires, and wherein the second pair of contacts include a second set of wires.

In some examples of the motor unit system, unmanned vehicle, and method described above, the first opening includes a portion of a housing opening and the second opening includes a portion of the housing opening, wherein the housing opening is a single opening. In some examples of the motor unit system, unmanned vehicle, and method described above, the second connector includes a third contact. Some examples of the motor unit system, unmanned vehicle, and method described above may further include a sensor contained within the housing.

In some examples of the motor unit system, unmanned vehicle, and method described above, the sensor is configured to transmit an output via the second connector. In some examples of the motor unit system, unmanned vehicle, and method described above, the first opening first opening and the second opening are separated by a housing portion.

### BRIEF DESCRIPTION OF THE DRAWINGS

FIG. 1 shows an example of a perspective view of a motor unit system of an unmanned vehicle in accordance with aspects of the present disclosure.

FIG. 2 shows an example of a front view of a motor unit system in accordance with aspects of the present disclosure.

FIG. 3 shows an example of a side view of a motor unit system in accordance with aspects of the present disclosure.

FIG. 4 shows an example of a power input and a data input in accordance with aspects of the present disclosure.

FIG. 5 shows an example of an exploded view of a motor unit system in accordance with aspects of the present disclosure.

FIG. 6 shows an example of a schematic of a motor unit system in accordance with aspects of the present disclosure.

FIG. 7 shows an example of a process for manufacturing a motor unit system in accordance with aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

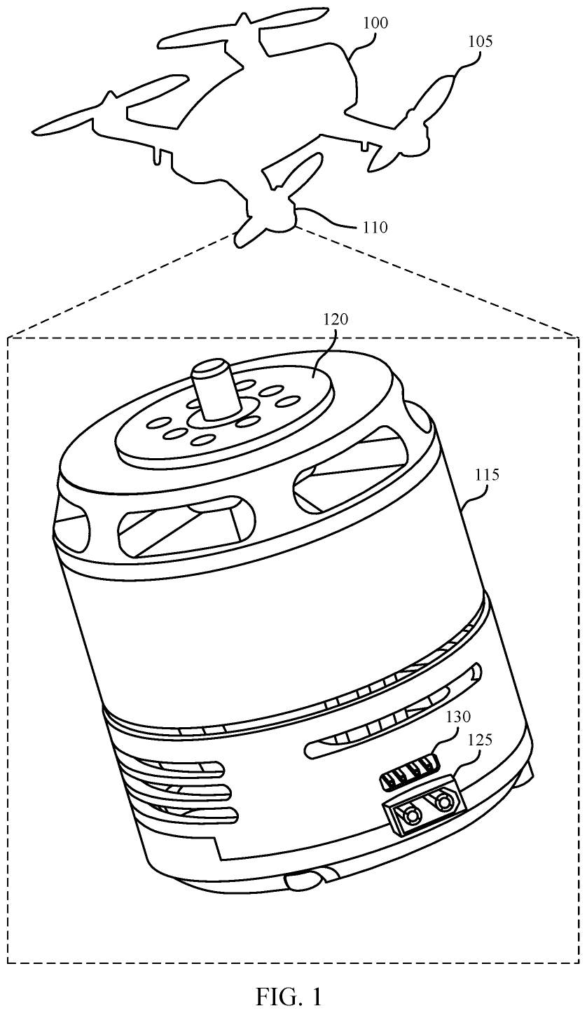

FIG. 1 shows an example of a perspective view of a motor unit system 110 of an unmanned vehicle 100 in accordance with aspects of the present disclosure. In some embodiments, the motor unit system 110 may be combined with other components to produce an unmanned aerial vehicle (UAV). For example, the motor unit system 110 may be connected to a frame of a UAV and may power a propulsion unit 105 such as a propeller.

The motor 120 may be powerful enough to lift wide array of vehicles and payloads and may be durable and reliable enough to perform in a wide variety of conditions. In some examples, the electronic speed control (ESC) may be pre-tuned for precision and efficiency and may be conformally coated to increased reliability.

An integrated light source may enable line-of-sight flying and may greatly improve visibility and safety. By combining the light source with the motor unit, the vehicle may achieve a desirable form factor. In some examples, a switch on the back of the motor unit system 110 may allow a user to dictate the direction of the rotor rotation.

By combining a motor 120 with an electronic speed control (ESC), the motor unit system 110 may enable faster and easier assembly as well as more robust performance. Some embodiments may be used in conjunction with a connector system that enables quick assembly without soldering. In some cases, the motor unit system 110 may also include a built-in direction switch and nav light switch (which may turn a built-in nav light on or off, change a color of the built-in nav light, or change operation or function of the built-in nav light, e.g., flashing or not flashing).

The motor unit system 110 may be configured with elements that enable durable and reliable performance in a variety of flight conditions. For example, an internal ESC may be conformally coated to protect the motor unit system 110 from damage in wet conditions.

In one embodiment, the propulsion unit 105 for a multi-rotor vehicle may have a 12-inch to 15-inch diameter, with a 3-inch to 5-inch pitch. For a fixed wing vehicle, the propulsion unit 105 may have a 9-inch to 13-inch Diameter, with a 5-inch to 9-inch pitch. In one embodiment, the total vehicle weight for a multi-rotor vehicle may be up to 1.5 KG per motor 120. In some fixed wing embodiments, the total weight may be up to 4 KG per motor 120.

In one embodiment, the motor 120 may operate at 3,515 revolutions per minute (RPM) and 500 kV. An example shaft size may be 4 mm, and an example weight for the motor unit system 110 may be from 150-200 g. The input voltage range may be between 10V-25.5V.

In some examples, the motor unit system 110 may be used in conjunction with a battery power source. For example, the battery may be a 4 cell to 6 cell Lithium polymer (LiPo) battery with 14.8 v-22.2 v Continuous Current, and 20 Amps (500 W), with a burst current of 35 Amps. However, one skilled in the art will recognize that other battery systems may be suitable for powering the motor unit system 110.

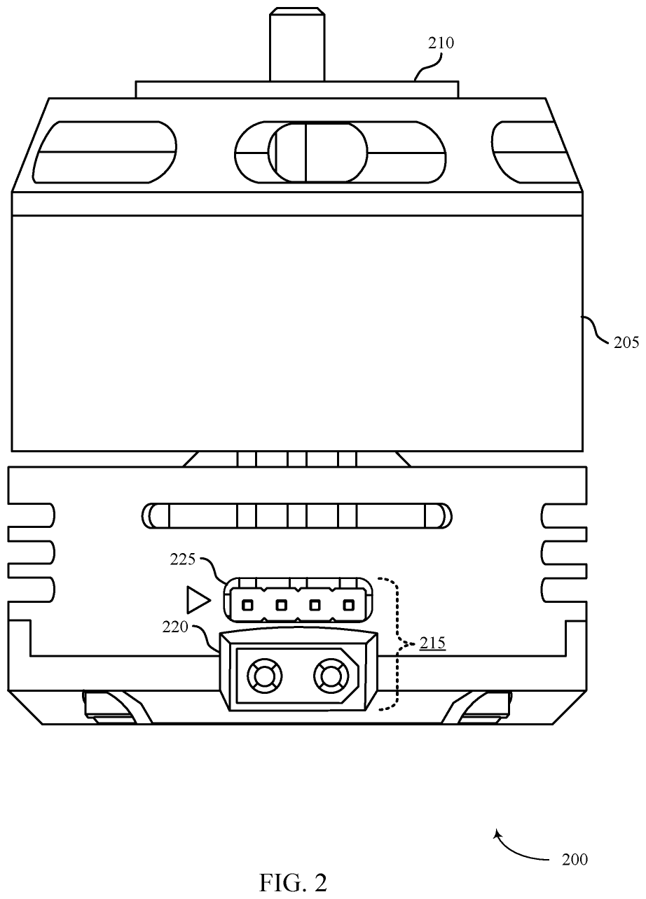

The motor unit system 110 may be configured with one or more solder-free connection points, so that the motor unit system 110 may be simply plugged into a vehicle. In some examples, the motor unit system 110 may include, or may be packaged with a pre-soldered cable and a connector system to connect the motor unit system 110 to a power input 125, a data input 130 (e.g., a throttle input), and a propulsion unit 105. Motor unit system 110 may be an example of, or include aspects of, the corresponding elements described with reference to FIGS. 2, 3, 5, and 6. Motor unit system 110 may include housing 115, motor 120, power input 125, and data input 130.

Housing 115 may have a circular cross-section and may include a plurality of mounting holes on one end of the housing 115. Housing 115 may be an example of, or include aspects of, the corresponding elements described with reference to FIGS. 2, 3, and 5.

Motor 120 may include a shaft and a winding, the shaft extending from inside the housing 115 to outside of the housing 115 through a hole at the one end of the housing 115 or another end of the housing 115, the other end of the housing 115 being opposite the one end of the housing 115, the winding being contained within the housing 115. Motor 120 may be an example of, or include aspects of, the corresponding elements described with reference to FIGS. 2, 3, 5, and 6.

Power input 125 may include a first connector accessible through a first opening in the housing 115, the first connector including a first pair of contacts electrically coupled to the motor controller at a power supply input of the motor controller. In some examples, the first pair of contacts include a first pair of pins. In some examples, the first pair of pins are fully contained within the housing 115.

In some examples, the first pair of contacts include a first pair of pins, and the second pair of contacts include a second pair of pins. In some examples, the first pair of pins are fully contained within the housing 115, and wherein the second pair of pins are fully contained within the housing 115. In some examples, the first pair of contacts include a first set of wires, and wherein the second pair of contacts include a second set of wires. Power input 125 may be an example of, or include aspects of, the corresponding elements described with reference to FIGS. 2-6.

Data input 130 may include a second connector adapted to operate independently from the first connector accessible through a second opening in the housing 115, the second connector including a second pair of contacts electrically coupled to the motor controller at a control input of the motor controller. Data input 130 may be connected to a sensor contained within the housing 115.

In some examples, the second pair of contacts include a second pair of pins. In some examples, the second pair of pins are fully contained within the housing 115. In some examples, the second connector includes a third contact. In some examples, the sensor is configured to transmit an output via the second connector. Data input 130 may be an example of, or include aspects of, the corresponding elements described with reference to FIGS. 2-6.

FIG. 2 shows an example of a front view of a motor unit system 200 in accordance with aspects of the present disclosure. Motor unit system 200 may be an example of, or include aspects of, the corresponding elements described with reference to FIGS. 1, 3, 5, and 6. Motor unit system 200 may include housing 205, motor 210, opening 215, power input 220, and data input 225.

Housing 205 may be an example of, or include aspects of, the corresponding elements described with reference to FIGS. 1, 3, and 5. Motor 210 may be an example of, or include aspects of, the corresponding elements described with reference to FIGS. 1, 3, 5, and 6.

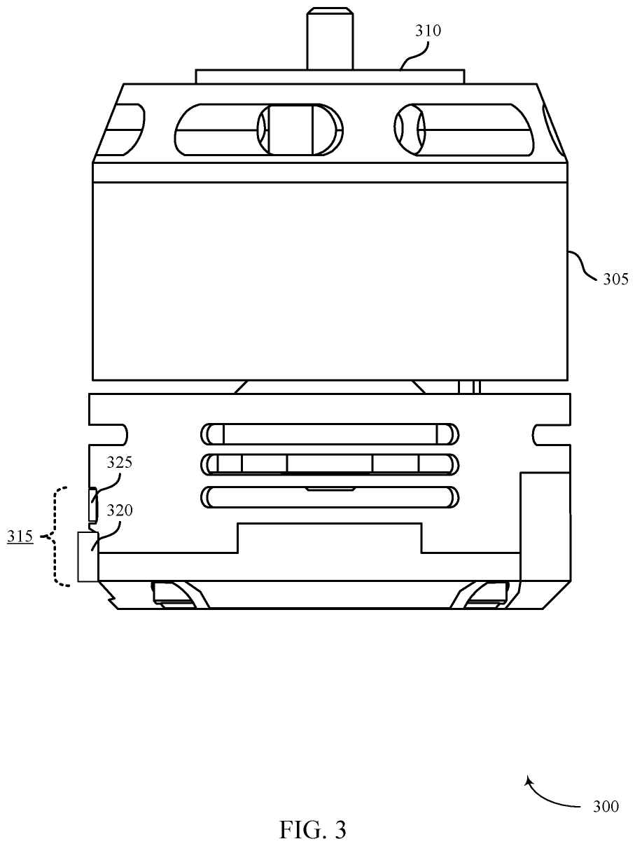

In one embodiment, opening 215 may be a single opening enabling access to both power input 220, and data input 225. In another embodiment, each input may have a separate opening. That is, a first opening may include a portion of opening 215 and a second opening 215 may include another portion of opening 215. In some examples, the first opening 215 first opening 215 and the second opening 215 are separated by a housing 205 portion. Opening 215 may be an example of, or include aspects of, the corresponding elements described with reference to FIG. 3.

Power input 220 and data input 225 may be examples of, or include aspects of, the corresponding elements described with reference to FIGS. 1, and 3-6.

FIG. 3 shows an example of a side view of a motor unit system 300 in accordance with aspects of the present disclosure. Motor unit system 300 may be an example of, or include aspects of, the corresponding elements described with reference to FIGS. 1, 2, 5, and 6. Motor unit system 300 may include housing 305, motor 310, opening 315, power input 320, and data input 325.

Housing 305 may be an example of, or include aspects of, the corresponding elements described with reference to FIGS. 1, 2, and 5. Motor 310 may be an example of, or include aspects of, the corresponding elements described with reference to FIGS. 1, 2, 5, and 6.

Opening 315 may be an example of, or include aspects of, the corresponding elements described with reference to FIG. 2. Power input 320 and data input 325 may be examples of, or include aspects of, the corresponding elements described with reference to FIGS. 1, 2, and 4-6.

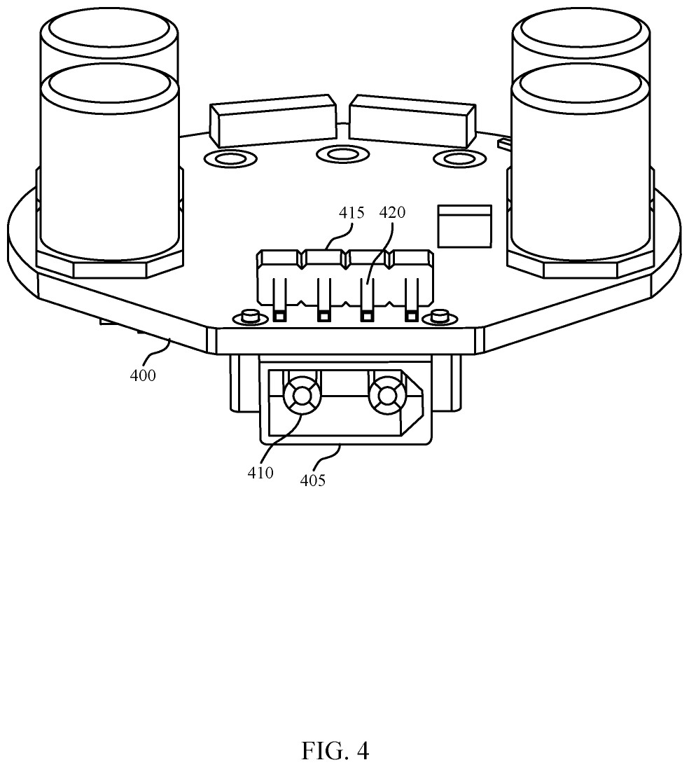

FIG. 4 shows an example of a power input 405 and a data input 415 in accordance with aspects of the present disclosure. The example shown includes circuit board 400, power input 405, and data input 415.

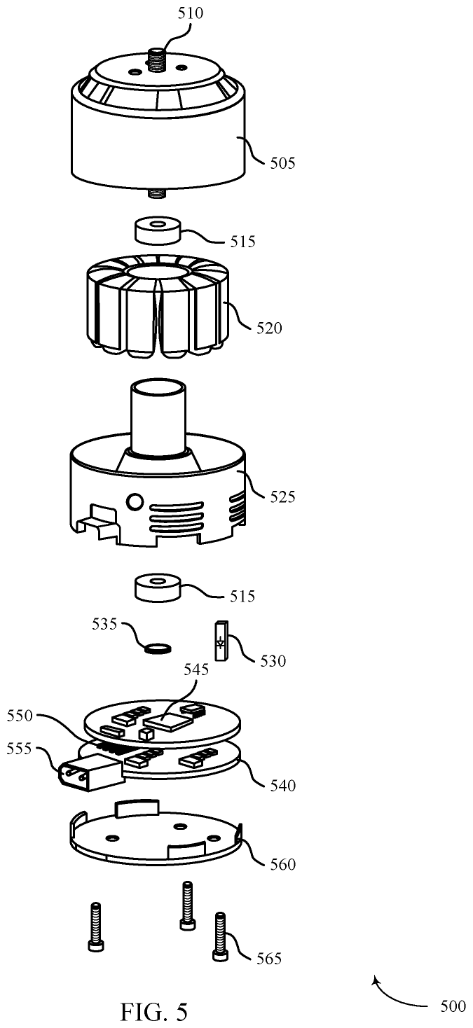

Circuit board 400 may be an example of, or include aspects of, the corresponding element described with reference to FIG. 5. Power input 405 may be an example of, or include aspects of, the corresponding elements described with reference to FIGS. 1-3, 5, and 6. Power input 405 may include power pins 410.

Data input 415 may be an example of, or include aspects of, the corresponding elements described with reference to FIGS. 1-3, 5, and 6. Data input 415 may include data pins 420.

The term ‘input’ as used herein may refer to a component of a motor unit that is capable of supplying electronic inputs. However, it should be noted that power input 405 and a data input 415 may also be capable to transmitting outputs from a motor unit system.

FIG. 5 shows an example of an exploded view of a motor unit system 500 in accordance with aspects of the present disclosure. Motor unit system 500 may be an example of, or include aspects of, the corresponding elements described with reference to FIGS. 1-3, and 6. Motor unit system 500 may include motor 505, shaft 510, ball bearing 515, winding 520, housing 525, light source 530, lock clip 535, circuit board 540, ESC 545, data input 550, power input 555, bottom cover 560, and fasteners 565.

Motor 505 may be an example of, or include aspects of, the corresponding elements described with reference to FIGS. 1-3, and 6. Housing 525 may be an example of, or include aspects of, the corresponding elements described with reference to FIGS. 1-3.

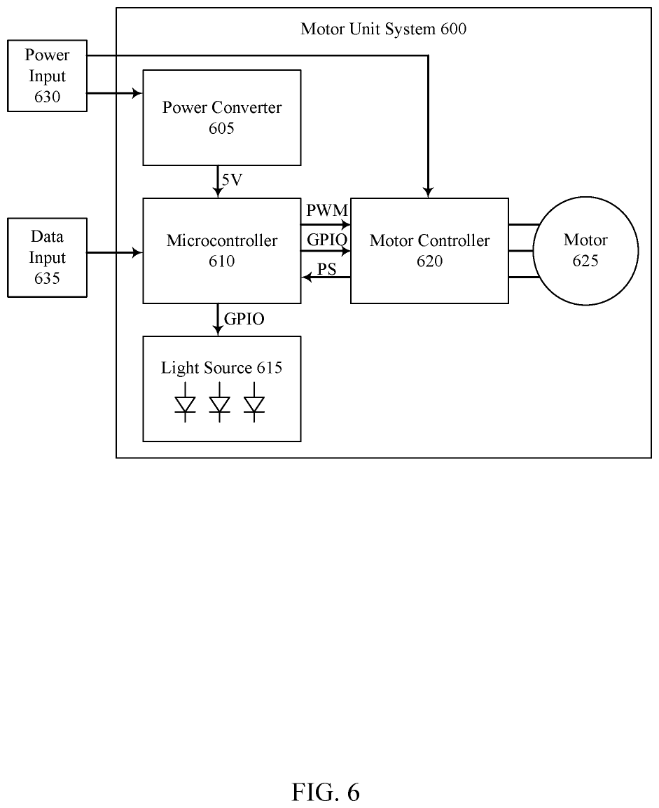

Light source 530 may be an example of, or include aspects of, the corresponding element described with reference to FIG. 6. Circuit board 540 may be an example of, or include aspects of, the corresponding elements described with reference to FIG. 4. Data input 550 and Power input 555 may be an example of, or include aspects of, the corresponding elements described with reference to FIGS. 1-4, and 6.

FIG. 6 shows an example of a schematic of a motor unit system 600 in accordance with aspects of the present disclosure. The example shown includes motor unit system 600, power input 630, and data input 635.

Motor unit system 600 may be an example of, or include aspects of, the corresponding elements described with reference to FIGS. 1-5. Motor unit system 600 may include power converter 605, microcontroller 610, light source 615, motor controller 620, and motor 625. Light source 615 may be an example of, or include aspects of, the corresponding elements described with reference to FIG. 5. In one example, light source 615 may include one or more navigational light emitting diode (LED) components.

Power input 630 may provide power to power converter 605 and motor controller 620. Power converter 605 may convert the power (e.g., by adjusting the voltage from 10V-25V to 5V) for consumption by the microcontroller 610. Microcontroller 610 may provide general purpose input/output (GPIO) to light source 615. In one example, microcontroller 610 may include or represent a light control coupled to light source 615. Microcontroller 610 may also provide pulse width modulation (PWM) and GPIO to motor controller 620. Motor controller 620 may provide phase sense (PS) feedback to microcontroller 610.

Motor controller 620 may be contained within the housing, and may be coupled to the motor 625. In one example, the motor controller 620 is an ESC. Motor 625 may be an example of, or include aspects of, the corresponding elements described with reference to FIGS. 1-3, and 5. Power input 630 may be an example of, or include aspects of, the corresponding elements described with reference to FIG. 5.

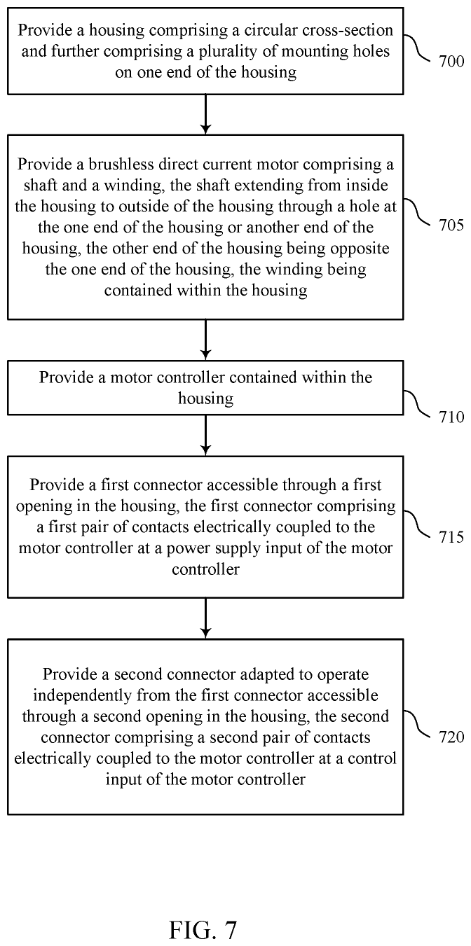

FIG. 7 shows an example of a process for manufacturing a motor unit system in accordance with aspects of the present disclosure. In some examples, these operations may be performed by a processor executing a set of codes to control functional elements of a manufacturing apparatus. Additionally or alternatively, the processes may be performed manually, or using special-purpose hardware. Generally, these operations may be performed according to the methods and processes described in accordance with aspects of the present disclosure. For example, the operations may be composed of various substeps, or may be performed in conjunction with other operations described herein.

At step 700, a manufacturing system may provide a housing including a circular cross-section and further including a plurality of mounting holes on one end of the housing. In some cases, the operations of this step may refer to a housing as described with reference to FIGS. 1-3, and 5.

At step 705, the manufacturing system may provide a brushless direct current motor including a shaft and a winding, the shaft extending from inside the housing to outside of the housing through a hole at the one end of the housing or another end of the housing, the other end of the housing being opposite the one end of the housing, the winding being contained within the housing. In some cases, the operations of this step may refer to a motor as described with reference to FIGS. 1-3, 5, and 6.

At step 710, the manufacturing system may provide a motor controller contained within the housing. In some cases, the operations of this step may refer to a motor controller as described with reference to FIG. 6.

At step 715, the manufacturing system may provide a first connector accessible through a first opening in the housing, the first connector including a first pair of contacts electrically coupled to the motor controller at a power supply input of the motor controller. In some cases, the operations of this step may refer to a power input as described with reference to FIGS. 1-6.

At step 720, the manufacturing system may provide a second connector adapted to operate independently from the first connector accessible through a second opening in the housing, the second connector including a second pair of contacts electrically coupled to the motor controller at a control input of the motor controller. In some cases, the operations of this step may refer to a data input as described with reference to FIGS. 1-6.

Some of the functional units described in this specification have been labeled as modules, or components, to more particularly emphasize their implementation independence. For example, a module may be implemented as a hardware circuit including custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions that may, for instance, be organized as an object, procedure, or function. Nevertheless, the executables of an identified module need not be physically located together but may include disparate instructions stored in different locations which, when joined logically together, include the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A motor unit system, comprising:
a housing comprising a circular cross-section and further comprising a plurality of mounting holes on one end of the housing;
a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
a motor controller contained within the housing;
a first connector accessible through a first opening in the housing, the first connector comprising a first pair of contacts electrically coupled to the motor controller at a power supply input of the motor controller; and
a second connector adapted to operate independently from the first connector accessible through a second opening in the housing, the second connector comprising a second pair of contacts electrically coupled to the motor controller at a control input of the motor controller.

2. The motor unit system of claim 1, wherein:
said first pair of contacts comprise a first pair of pins.

3. The motor unit system of claim 2, wherein:
said first pair of pins are fully contained within the housing.

4. The motor unit system of claim 1, wherein:
said second pair of contacts comprise a second pair of pins.

5. The motor unit system of claim 4, wherein:
said second pair of pins are fully contained within the housing.

6. The motor unit system of claim 1, wherein:
said first pair of contacts comprise a first pair of pins, and said second pair of contacts comprise a second pair of pins.

7. The motor unit system of claim 6, wherein:
said first pair of pins are fully contained within the housing, and wherein said second pair of pins are fully contained within the housing.

8. The motor unit system of claim 1, wherein:
said first pair of contacts comprise a first set of wires, and wherein said second pair of contacts comprise a second set of wires.

9. The motor unit system of claim 1, wherein:
said first opening comprises a portion of a housing opening and said second opening comprises a portion of the housing opening, wherein the housing opening is a single opening.

10. The motor unit system of claim 1, wherein:
said second connector comprises a third contact.

11. The motor unit system of claim 10, the motor unit system further comprising:
a sensor contained within the housing.

12. The motor unit system of claim 11, wherein:
said sensor is configured to transmit an output via the said second connector.

13. The motor unit system of claim 1, wherein:
said first opening first opening and said second opening are separated by a housing portion.

14. An unmanned vehicle comprising:
a frame, one or more propulsion units, a battery unit, and a motor unit system, the motor unit system further comprising:
a housing comprising a circular cross-section and further comprising a plurality of mounting holes on one end of the housing;
a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
a motor controller contained within the housing;
a first connector accessible through a first opening in the housing, the first connector comprising a first pair of contacts electrically coupled to the motor controller at a power supply input of the motor controller; and
a second connector adapted to operate independently from the first connector accessible through a second opening in the housing, the second connector comprising a second pair of contacts electrically coupled to the motor controller at a control input of the motor controller.

15. The unmanned vehicle of claim 14, wherein:
said first pair of contacts comprise a first pair of pins.

16. The unmanned vehicle of claim 15, wherein:
said first pair of pins are fully contained within the housing.

17. The unmanned vehicle of claim 14, wherein:
said second pair of contacts comprise a second pair of pins.

18. The unmanned vehicle of claim 17, wherein:
said second pair of pins are fully contained within the housing.

19. The unmanned vehicle of claim 14, wherein:
said first pair of contacts comprise a first pair of pins, and said second pair of contacts comprise a second pair of pins.

20. The unmanned vehicle of claim 19, wherein:
said first pair of pins are fully contained within the housing, and wherein said second pair of pins are fully contained within the housing.

21. The unmanned vehicle of claim 14, wherein:
said first pair of contacts comprise a first set of wires, and wherein said second pair of contacts comprise a second set of wires.

22. The unmanned vehicle of claim 14, wherein:
said first opening comprises a portion of a housing opening and said second opening comprises a portion of the housing opening, wherein the housing opening is a single opening.

23. The unmanned vehicle of claim 14, wherein:
said second connector comprises a third contact.

24. The unmanned vehicle of claim 23, the unmanned vehicle further comprising:
a sensor contained within the housing.

25. The unmanned vehicle of claim 24, wherein:
said sensor is configured to transmit an output via the said second connector.

26. The unmanned vehicle of claim 14, wherein:
said first opening first opening and said second opening are separated by a housing portion.

27. A method of manufacturing a motor unit system, the method comprising:
providing a housing comprising a circular cross-section and further comprising a plurality of mounting holes on one end of the housing;
providing a brushless direct current motor comprising a shaft and a winding, the shaft extending from inside the housing to outside of the housing through a hole at the one end of the housing or another end of the housing, the other end of the housing being opposite the one end of the housing, the winding being contained within the housing;
providing a motor controller contained within the housing;
providing a first connector accessible through a first opening in the housing, the first connector comprising a first pair of contacts electrically coupled to the motor controller at a power supply input of the motor controller; and
providing a second connector adapted to operate independently from the first connector accessible through a second opening in the housing, the second connector comprising a second pair of contacts electrically coupled to the motor controller at a control input of the motor controller.

28. The method of claim 27, wherein:
said first pair of contacts comprise a first pair of pins.

29. The method of claim 28, wherein:
said first pair of pins are fully contained within the housing.

30. The method of claim 27, wherein:
said second pair of contacts comprise a second pair of pins.

31. The method of claim 30, wherein:
said second pair of pins are fully contained within the housing.

32. The method of claim 27, wherein:
said first pair of contacts comprise a first pair of pins, and said second pair of contacts comprise a second pair of pins.

33. The method of claim 32, wherein:
said first pair of pins are fully contained within the housing, and wherein said second pair of pins are fully contained within the housing.

34. The method of claim 27, wherein:
said first pair of contacts comprise a first set of wires, and wherein said second pair of contacts comprise a second set of wires.

35. The method of claim 27, wherein:
said first opening comprises a portion of a housing opening and said second opening comprises a portion of the housing opening, wherein the housing opening is a single opening.

36. The method of claim 27, wherein:
said second connector comprises a third contact.

37. The method of claim 36, the method further comprising:
providing a sensor contained within the housing.

38. The method of claim 37, wherein:
said sensor is configured to transmit an output via the said second connector.

39. The method of claim 27, wherein:
said first opening first opening and said second opening are separated by a housing portion.
